(19) United States
(12) Patent Application Publication
(10) Pub. No.: US 2008/0246666 A1
(43) Pub. Date: Oct. 9, 2008

(54) Mobile terminal

(75) Inventor: Hyun Kang, Seongnam-si (KR)

Correspondence Address: HARNESS, DICKEY & PIERCE, P.L.C., P.O. BOX 8910, RESTON, VA, 20195, US

(73) Assignee: KTF TECHNOLOGIES, INC.

(21) Appl. No.: 12/078,667

(22) Filed: Apr. 3, 2008

(30) Foreign Application Priority Data
Apr. 3, 2007 (KR) 10-2007-0032793

(51) Int. Cl. H01Q 1/38

(52) U.S. Cl. 343/700 MS

(57) ABSTRACT

A mobile terminal is disclosed. With a mobile terminal which includes a printed circuit board, a first cover and a second cover which house the printed circuit board, and an antenna pattern which is formed on an inner surface of one of the first cover and the second cover and which is connected to the printed circuit board, where the antenna pattern is formed from conductive ink, the volume of the mobile terminal can be reduced, and because there is no need to fabricate a cast, it is easy to alter the antenna pattern.

### CROSS-REFERENCE TO RELATED APPLICATIONS

This application claims the benefit of Korean Patent Application No. 10-2007-0032793 filed with the Korean Intellectual Property Office on Apr. 3, 2007, the disclosure of which is incorporated herein by reference in its entirety.

### BACKGROUND

1. Technical Field

The present invention relates to a mobile terminal.

2. Description of the Related Art

The antenna of a mobile terminal is typically an external antenna, and is equipped on the mobile terminal protruding outwards to the exterior. Not only can this be inconvenient in use, but also the antenna may easily be damaged due to carelessness of the user. With the mobile terminal becoming smaller and more sophisticated, however, the conventional external antenna is being replaced by the internal, or built-in, antenna. Much effort is being focused on technological developments for antenna types that can be installed within a mobile terminal while providing communication services to a satisfactory level. Examples of such antennas may include the patch antenna and the printed antenna, which can be formed on the circuit board, as well as antennas that can be printed onto a thin film.

When using space diversity or when implementing a mobile solution such as WLAN (Wireless LAN), Zigbee, Bluetooth, WiBro (Wireless Broadband Internet), etc., there is a need for an additional antenna, and accordingly, the miniature-size ceramic antenna or PCB (printed circuit board) mount type built-in antenna is widely being used.

Such an internal antenna includes a carrier, fabricated from plastic, and a pattern antenna, fabricated from metal, where the pattern antenna is connected to a printed circuit board. As such, the conventional internal antenna may require a cast for fabricating the carrier and pattern, and according to the type of the mobile terminal, may require separate casts for the carrier and antenna pattern. Also, since the carrier acts as a support for the antenna pattern and thus occupies a particular amount of space, the overall volume of the mobile terminal may have to be increased.

### SUMMARY

An aspect of the invention is to provide a mobile terminal, of which the volume can be reduced.

Another aspect of the invention is to provide a mobile terminal, which allows easy alteration of the antenna pattern.

One aspect of the invention provides a mobile terminal that includes a printed circuit board, a first cover and a second cover which house the printed circuit board, and an antenna pattern which is formed on an inner surface of one of the first cover and the second cover and which is connected to the printed circuit board, where the antenna pattern is formed from conductive ink.

Another aspect of the invention provides a mobile terminal that includes a printed circuit board, a first cover and a second cover which house the printed circuit board, and an antenna pattern which is formed on an inner surface of one of the first cover and the second cover and which is connected to the printed circuit board, where the antenna pattern is formed by vacuum deposition.

Embodiments of the mobile terminal according to certain aspects of the invention may include one or more of the following features. For example, the conductive ink may contain 65 to 70 weight % of silver particles. The antenna pattern may be connected to the printed circuit board by at least one connection terminal, and the connection terminal may be a pogo pin. The first cover and the second cover can be formed from a dielectric material.

Additional aspects and advantages of the present invention will be set forth in part in the description which follows, and in part will be obvious from the description, or may be learned by practice of the invention.

### BRIEF DESCRIPTION OF THE DRAWINGS

FIG. 1 is an exploded perspective view of a mobile terminal according to an embodiment of the invention.

FIG. 2 is a perspective view of a mobile terminal according to another embodiment of the invention, in which a protective film is stacked for vacuum deposition.

### DETAILED DESCRIPTION

The mobile terminal according to certain embodiments of the invention will be described below in more detail with reference to the accompanying drawings. Those components that are the same or are in correspondence are rendered the same reference numeral regardless of the figure number, and redundant explanations are omitted.

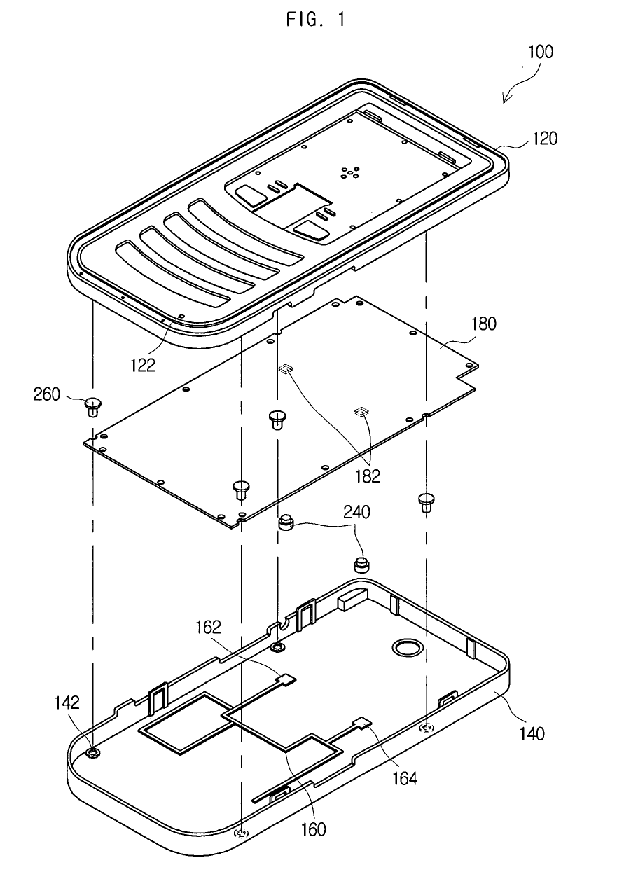

FIG. 1 is an exploded perspective view of a mobile terminal according to an embodiment of the invention. In FIG. 1, the mobile terminal is illustrated with certain electronic components omitted (e.g. chip, camera module, keypad, etc.), which would generally be included inside the mobile terminal.

Referring to FIG. 1, a mobile terminal 100 according to an embodiment of the invention may include a printed circuit board 180, and a first case 120 and a second case 140 which can house the printed circuit board 180 and various other electronic components (not shown) within. An antenna pattern 160 can be formed on an inside surface of the first case 120, where the antenna pattern 160 can be formed from conductive ink.

In the mobile terminal 100 according to this embodiment, the antenna may be formed inside the terminal, allowing the terminal to provide a smaller bulk and a more attractive appearance. Also, as the antenna pattern can be attached by the conductive ink to the mobile terminal's case, it can be easier to fabricate the antenna, and since the need for a carrier is obviated, the overall volume of the mobile terminal can be reduced. Furthermore, with the antenna pattern formed from conductive ink, the form of the antenna pattern can be freely modified without having to prepare a cast.

The printed circuit board (PCB) 180 may be positioned inside the first case 120 and second case 140, and can be secured by screws 260 which join the first case 120 to second case 140. Various chips (not shown) can be mounted on the printed circuit board 180. In addition, numerous circuit patterns (not shown) can be formed on the printed circuit board 180, where the circuit patterns may be connected to connection parts 182.

A connection part 182 can be formed on one side of the printed circuit board 180 and can be connected with one or more circuit patterns. When the mobile terminal 100 is assembled, the connection parts 182 may be placed in contact with the connection terminals 220. The number and shape of the connection parts 182 may vary as necessary.

The first case 120 and the second case 140 may be joined by screws 260 to form the outer body of the mobile terminal. The first and second cases 120, 140 can be joined to compose a bar type mobile terminal, or compose a part or the whole of a folder type or slide type mobile terminal.

Inside the first case 120 and second case 140 is formed the antenna pattern 160. The antenna pattern 160 may be attached to the terminal's case without being mounted on a separate carrier, which not only reduces the number of components in the mobile terminal but also reduces the volume. The antenna pattern 160 can be formed on either of the first case 120 and the second case 140 as necessary.

Since the antenna pattern 160 may be formed inside the first case 120 and second case 140, and as electrical power may be supplied to the antenna pattern 160, the first case 120 and the second case 140 can be formed from a dielectric material. Examples of dielectric material include polyethylene, polyvinyl chloride, acrylonitrile-butadiene-styrene (ABS) resins, etc.

The first case 120 and the second case 140 can have multiple coupling holes 122, 144 formed facing each other, for joining the first case 120 and the second case 140. Screws 260 can be inserted in the coupling holes 122, 144 to join the first case 120 and the second case 140 to each other. Of course, various other coupling methods may be used besides using screws, such as using adhesive, etc.

The antenna pattern 160 can be formed by printing conductive ink inside the first case 120 or the second case 140. The conductive ink can be a composition having 65 to 70 weight % of silver (Au) and 30 to 35 weight % of additives. Here, additives can be a mixture including resins, drying agents, and dispersing agents. A resin may serve to prevent the silver (Au) from directly contacting oxygen and thus prevent corrosion, and a drying agent may serve to facilitate the drying of the ink and thus reduce the time required for fabricating the antenna, while a dispersing agent may serve to improve the dispersion of the silver particles. Of course, the conductive ink may include materials other than silver, such as gold, copper, palladium, tin, or alloys thereof.

When fabricating the antenna pattern 160 in this way using conductive ink, there is no need for a cast in fabricating the antenna pattern, and therefore manufacturing costs may be reduced. Also, since the antenna pattern may be formed on the first case 120 or the second case 140, there is no need for a separate carrier, and therefore the volume of the mobile terminal may be decreased.

The antenna pattern 160 may include a ground part 162 and a terminal part 164, both of which may be in contact with connection terminals 220. In this way, the antenna pattern 160 can be connected with the printed circuit board 180. The connection terminals 220 may thus connect the antenna pattern 160 with the printed circuit board 180, and may be formed by pogo pins. A pogo pin refers to a spring connector, which may include electrical contact points with a spring interposed in-between such that the electrical contact points may extend and contract in a longitudinal direction. The electrical connection between the antenna pattern 160 and the printed circuit board 180 is not limited to implementation by pogo pins, and other similar structures may be used.

As such, an antenna pattern 160 according to this particular embodiment can be formed from conductive ink. In another embodiment of the invention, however, the antenna pattern can be formed by vacuum deposition.

Vacuum deposition is a method of coating a film over an object in a vacuous state. The principle of vacuum deposition is to place the object that is to be coated and the material that is to form the film inside a chamber, apply a vacuum within the chamber, and applying heat to melt and evaporate the material. The evaporated material forms vapor molecules, which collide with and attach to the object of coating, to form a film. Methods of heating and melting the material include electric resistance heating types, electron beam types, high-frequency induction types, laser types, etc.

Vacuum deposition offers a quick way of forming a film and entails simple equipment, and it is also easy to adjust the thickness of the film using a shutter, etc. Furthermore, vacuum deposition provides a film with high purity, when forming the film in a high vacuum.

As such, if vacuum deposition is used to form the antenna pattern on the first case 120 or the second case 140 of the mobile terminal, the fabrication time of the antenna pattern can be reduced, the thickness of the antenna pattern can readily be controlled, and an antenna pattern of a high purity can be obtained.

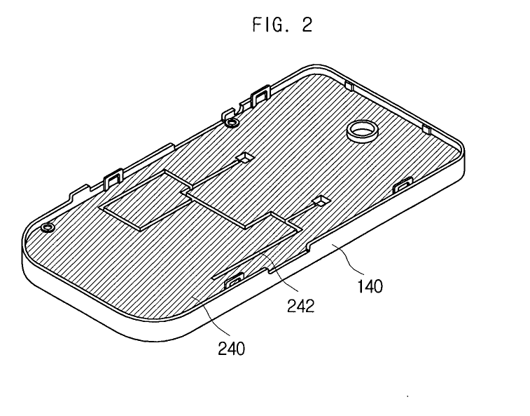

To form the antenna pattern 160 on the first case 120 or second case 140 using vacuum deposition, a protective film 240 may be stacked, as illustrated in FIG. 2, over the case where the antenna pattern is to be formed (which, in FIG. 2, is the first case 120). Holes 242 may be formed in the protective film 240 that correspond with the antenna pattern that will be formed. The vapor material may be deposited through these holes 242 to form the antenna pattern, while deposition may be prevented by the protective film 240 in portions excluding the holes 242.

As set forth above, certain aspects of the invention provide a mobile terminal, of which the volume can be reduced. Certain aspects of the invention provide a mobile terminal, in which it is easy to modify the antenna pattern.

While the spirit of the invention has been described in detail with reference to particular embodiments, the embodiments are for illustrative purposes only and do not limit the invention. It is to be appreciated that those skilled in the art can change or modify the embodiments without departing from the scope and spirit of the invention.

What is claimed is:

1. A mobile terminal comprising:
a printed circuit board;
a first cover and a second cover configured to house the printed circuit board; and
an antenna pattern formed on an inner surface of one of the first cover and the second cover and connected to the printed circuit board,
wherein the antenna pattern is formed from conductive ink.

2. The mobile terminal of claim 1, wherein the conductive ink contains 65 to 70 weight % of silver particles.

3. The mobile terminal of claim 1, wherein the antenna pattern is connected to the printed circuit board by at least one connection terminal.

4. The mobile terminal of claim 3, wherein the connection terminal is a pogo pin.

5. The mobile terminal of claim 1, wherein the first cover and the second cover are formed from a dielectric material.

6. A mobile terminal comprising:
a printed circuit board;
a first cover and a second cover configured to house the printed circuit board; and
an antenna pattern formed on an inner surface of one of the first cover and the second cover and connected with the printed circuit board,
wherein the antenna pattern is formed by vacuum deposition.

7. The mobile terminal of claim 6, wherein the antenna pattern is connected to the printed circuit board by at least one connection terminal.

8. The mobile terminal of claim 7, wherein the connection terminal is a pogo pin.

9. The mobile terminal of claim 6, wherein the first cover and the second cover are formed from a dielectric material.
